(19) United States
(12) Patent Application Publication
(10) Pub. No.: US 2011/0120272 A1
(43) Pub. Date: May 26, 2011

(54) RATCHET WRENCH WITH VARIABLE OUTPUT TORQUE

(76) Inventors: YING-HAO PENG, Tanzi Township (TW); Chia-Hui Peng, Tanzi Township (TW)

(21) Appl. No.: 12/876,231

(22) Filed: Sep. 6, 2010

(30) Foreign Application Priority Data
Sep. 7, 2009 (TW) 098130028

(51) Int. Cl. B25B 13/46; B25B 23/16

(52) U.S. Cl. 81/63.1; 81/60

(57) ABSTRACT

A ratchet wrench with variable output torque includes a wrench body, a control bar, a control pin, and a handle. The body includes a shank having an end forming a driving section for coupling with a socket and an opposite end pivotally connected to an end of the control bar through a pivot pin. The pivot pin is substantially normal to but not intersecting a central axis of the driving section so that the control bar is rotatable about the pivot pin for angular displacement. The control pin controls angular displacing between the control bar and the shank. The handle forms a bore slidably and slidably receiving the control bar to thereby form an extendible/contractible handle arrangement constituted by the handle, the control bar, and the shank. The handle is freely rotatable about an outer circumference of the control bar for efficient and effective operation of rotating the driving section.

### (a) TECHNICAL FIELD OF THE INVENTION

The present invention generally relates to a ratchet wrench, which is adjustable according practical applications in order provide flexibility of operation for the wrench.

### (b) DESCRIPTION OF THE PRIOR ART

A conventional ratchet wrench comprises a handle having an end to which a working head is mounted. The working head comprises a ratchet mechanism mounted therein. The ratchet mechanism is connected to a driving section that is selectively coupled to a socket or a bolt, whereby through successive application of torque to the handle through reciprocal movement, the ratchet mechanism may drive the driving section in a single given direction for fast tightening or loosening a bolt.

The handle of the conventional ratchet wrench is, however, a fixed one and does not allow for angular adjustment resembling a knuckle joint according to the limitation of an operation space in a working site. This makes the operation and use of the conventional ratchet wrench inconvenient at a location under for example an automobile or above a ceiling.

Further, in using the fixed handle to tighten or loosen a bolt, due to the non-adjustability of the length thereof, torque applied by the wrench must be controlled through hand perception. This often leads to a waste of time or excessive application of force or torque.

A ratchet wrench with angle-adjustable handle or a ratchet wrench with length-adjustable handle is available in the market for coping with such problems. However, such ratchet wrenches with handle adjustability are usually of no universal use and further, abrasion may be induced on a user's palm holding the handle when the handle is set at an effective length to supply the minimum torque output.

### SUMMARY OF THE INVENTION

Thus, the present invention aims to provide a ratchet wrench with variable torque output, which shows the following advantages:

(1) The ratchet wrench has a handle that is adjustable in a fashion resembling a knuckle joint for selectively setting an included angle between the handle and a central axis of a driving section, so that the use of the ratchet wrench is not limited by an operation space of a working site.

(2) The ratchet wrench has a handle that is adjustable in respect of an overall length thereof in order to selectively change a torque output thereof and thus realizing saving of time and/or effort.

(3) The ratchet wrench has a handle that when set in a minimum torque operation condition, can be positioned at an angle of 90 degrees with respect to the wrench but free of the drawbacks of abrasion of palm and wastes of time, so as to provide a novel structure of ratchet wrench suitable for operations requiring small torques.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view showing a ratchet wrench according to an embodiment of the present invention.

FIG. 2 is a perspective view of the ratchet wrench according to the present invention in an assembled form.

FIG. 3A is a cross-sectional view showing a control pin fixing a control bar and a shank of the ratchet wrench according to the present invention.

FIG. 3B is a cross-sectional view showing a control pin releasing a control bar and a shank of the ratchet wrench according to the present invention.

FIG. 3C is a cross-sectional view showing a minimum torque output condition where the control bar and the shank of the ratchet wrench of the present invention are substantially perpendicular to each other.

FIG. 3D is a cross-sectional view illustrating an application of the minimum torque output condition shown in FIG. 3C.

FIG. 4 is a cross-sectional view illustrating adjustment of included angle between the control bar and the shank of the ratchet wrench of the present invention.

FIGS. 5A, 5B, and 5C are cross-sectional views illustrating adjustment of length of the control bar and a handle of the ratchet wrench according to the present invention.

FIGS. 6A, 6B, and 6C are cross-sectional views illustrating adjustment of length of a control bar and a handle of a ratchet wrench according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

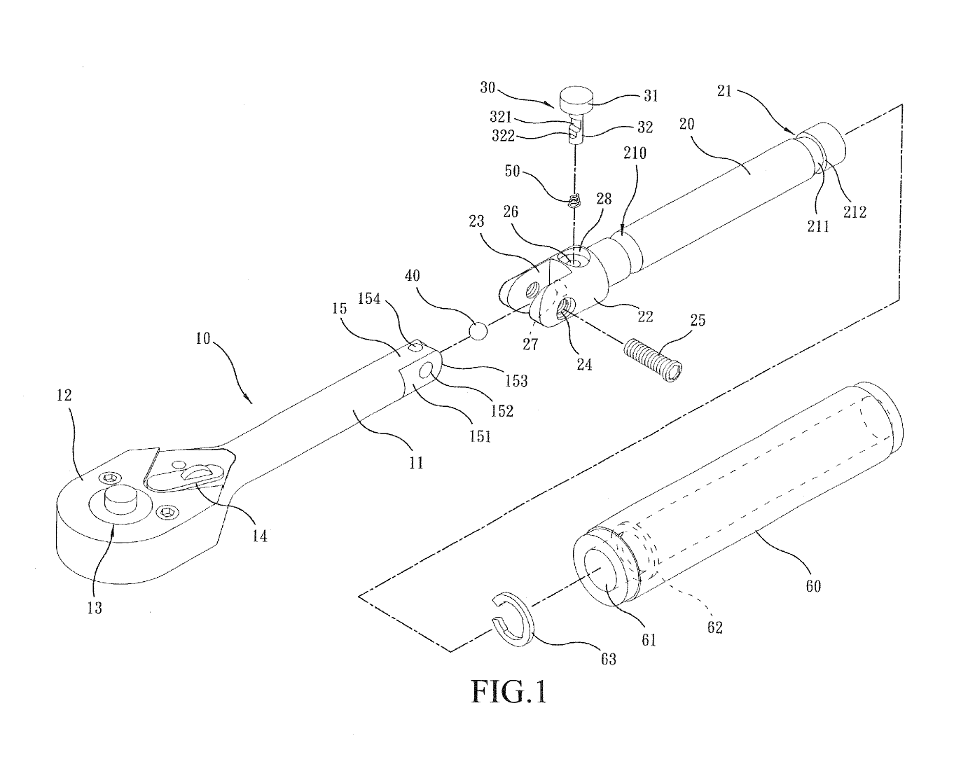

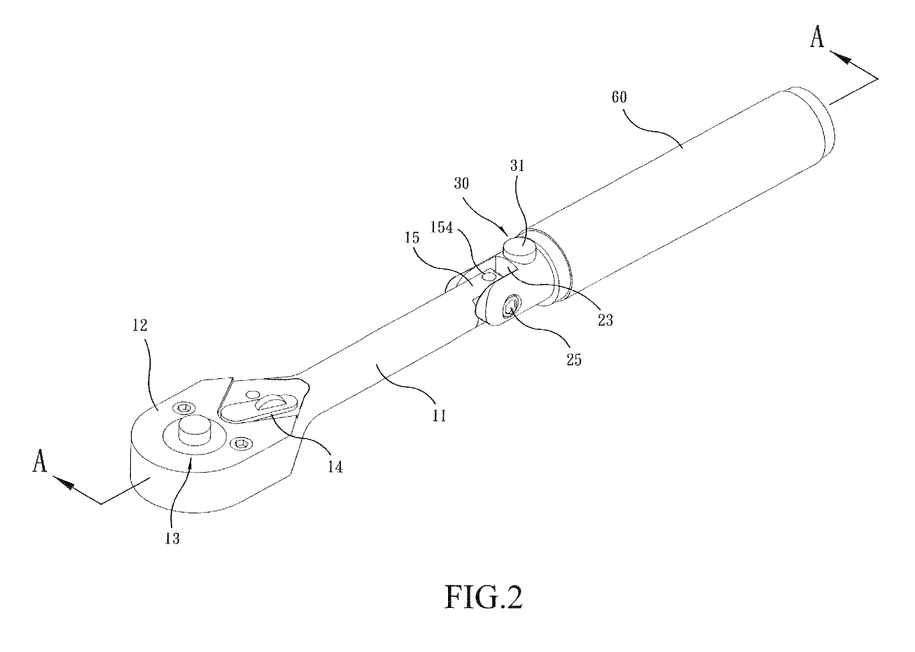

Referring to FIGS. 1, 2, and 3A, the present invention provides a ratchet wrench with variable output torque. The ratchet wrench according to the present invention comprises the following components:

A wrench body (10) comprises a shank (11), a head (12) connected to an end of the shank (11), a ratchet mechanism (13) mounted inside the head (12), a driving section (131) that is rotated by the ratchet mechanism (13) in a single predetermined direction, and a direction switch (14) that switches rotating direction of the ratchet mechanism (13). The shank (11) has an opposite end forming a joint section (15). The joint section (15) is formed to comprise two substantially parallel flat surfaces (151), a pivot hole (152) extending through both flat surfaces (151) in a direction substantially perpendicular to but not intersecting a central axis of the driving section (131), a curved surface (153) formed on an end surface of the joint section (15) around a center defined by the pivot hole (152), and a plurality of dimples (154) defined in a spaced manner in the curved surface (153).

A control bar (20) has two end sections, and each end section is circumferentially recessed to form a positioning slot (21, 210). Each of the two positioning slots (21, 210) is delimited by an inclined guide face (211), which converges in a direction toward the end of the control bar, and a stop wall (212), which shows an abrupt increase of diameter at a minimum diameter of the inclined guide face (211). Also, at one of the ends of the control bar (20), a diameter expanded knuckle seat (22) is formed. The knuckle seat (22) has an end surface that is recessed to form a knuckle slot (23) that diametrically extends through the knuckle seat (22). The knuckle slot (23) is thus delimited by two opposite side walls, which respectively mate with the two flat surfaces (15) of the joint section (15), when the joint section (15) is received in the knuckle slot (23). Aligned joint holes (24), which are internally threaded, are formed in the two side walls at locations corresponding to the pivot hole (152) of the joint section (15), whereby a pivot pin (25), which is externally threaded, is engageable and received through the joint holes (24) and further rotatably received through the pivot hole (152). As a result, the control bar (20) is allowed to take angular movement about a center defined by the pivot pin (25) and the pivot hole (152). The knuckle seat (22) also forms an insertion hole (26), which extends in a direction substantially parallel to a slot bottom of the knuckle slot (23). A ball hole (27) is formed in the slot bottom of the knuckle slot (23) and communicates the insertion hole (26). The knuckle seat (22) forms a recessed cavity (28) at an outer end of the insertion hole (26) and the cavity (28) has a diameter greater than the insertion hole (26).

A depressible control pin (30) is provided for controlling angular positioning between the control bar (20) and the shank (11). The control pin (30) comprises a head portion (31) that is receivable into/withdrawable out of the recessed cavity (28) and a post (32) that is slidably received in the insertion hole (26). The post (32) has a circumferential surface that is recessed in a radial direction to form a receiving trough (321) having a predetermined depth and a locking trough (322) immediately next to the receiving trough (321) and having a depth smaller than the predetermined depth of the receiving trough (321), whereby a slope is formed between the different depths of the receiving trough (321) and the locking trough (322). In the embodiment illustrated, the locking trough (322) is located below (namely in the direction away from the head portion of the control pin) the receiving trough (321).

A ball (40) is movably received in the ball hole (27).

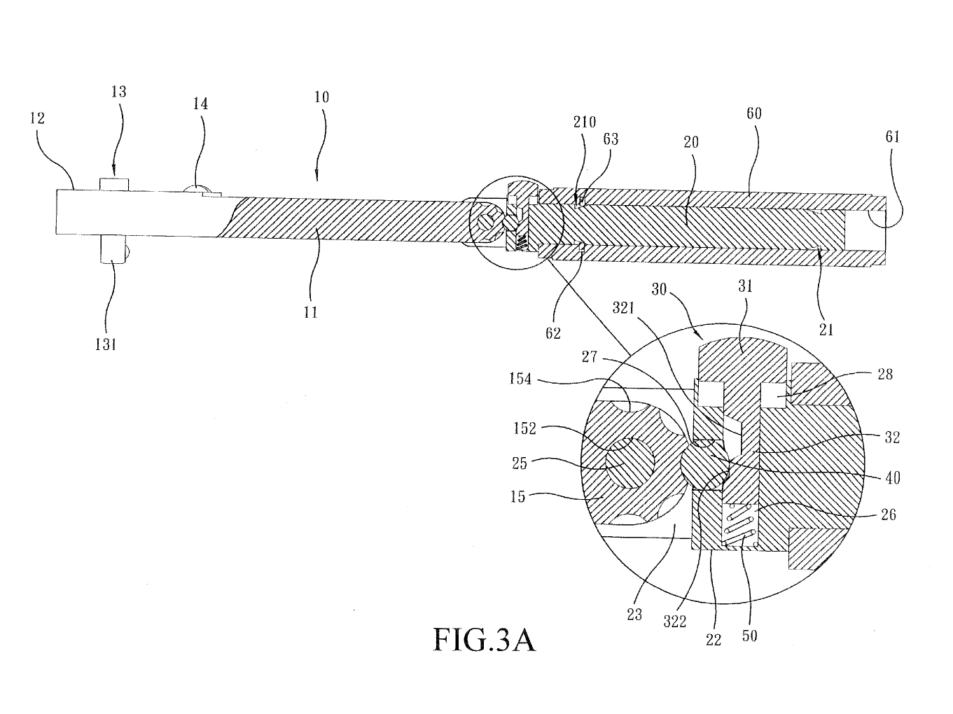

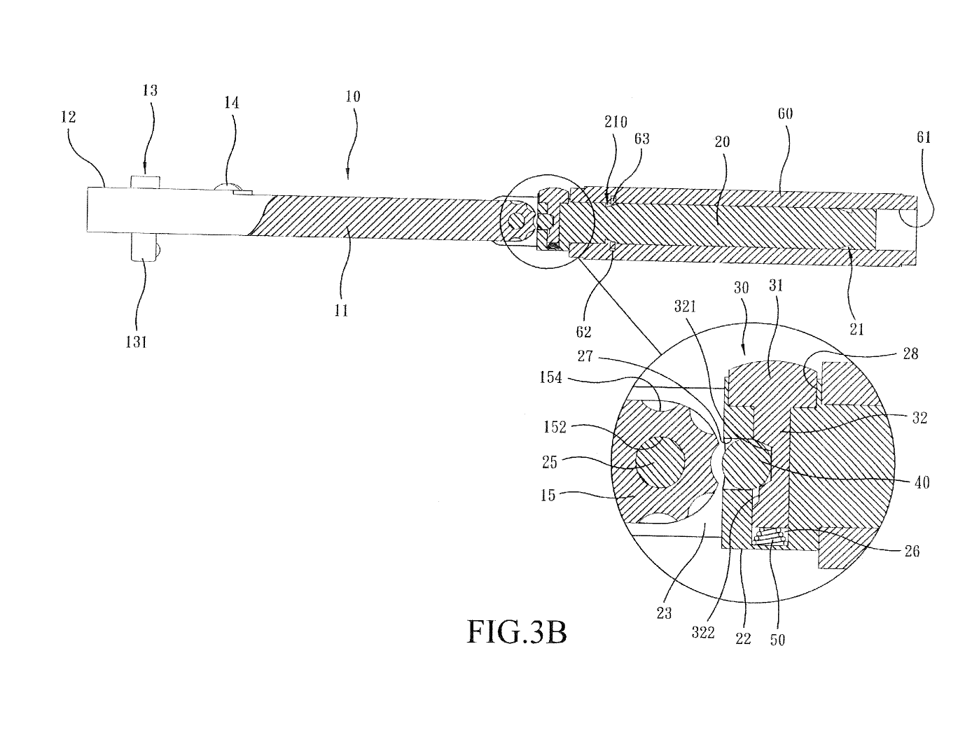

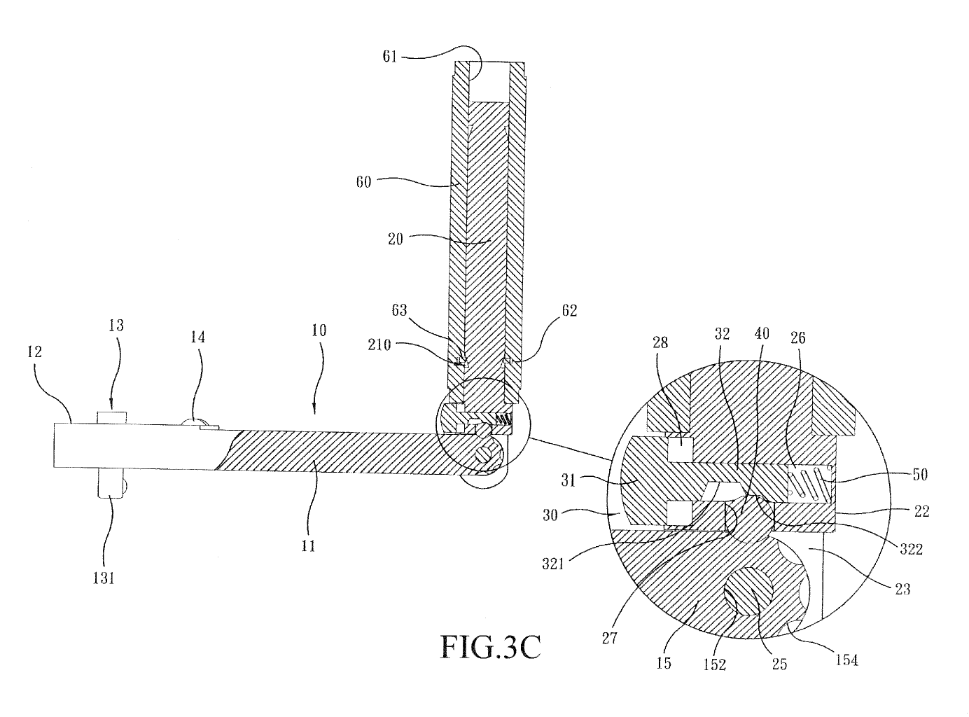

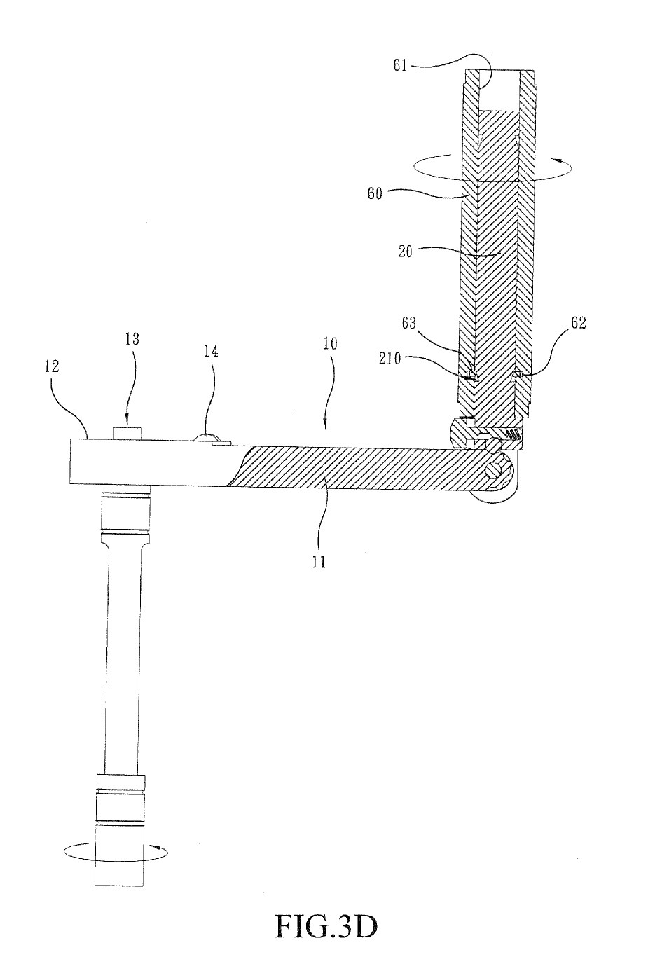

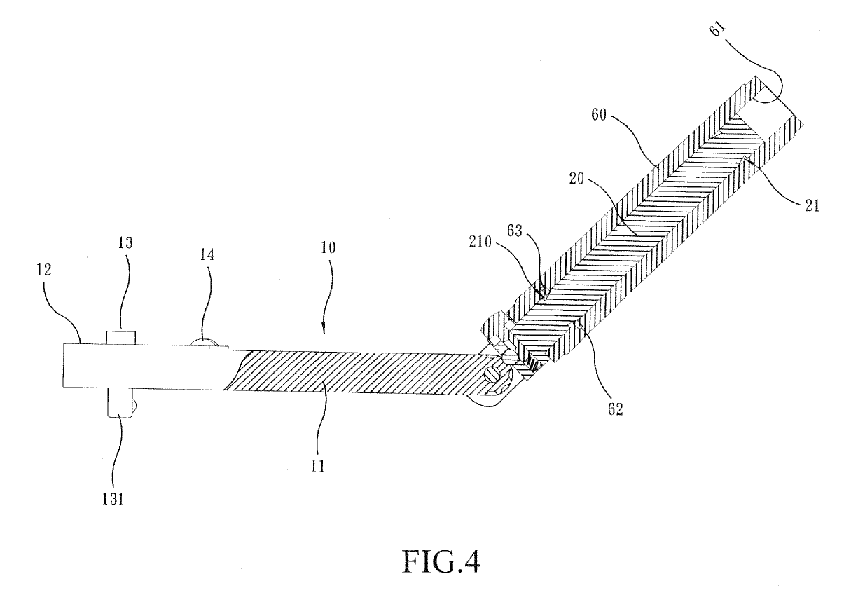

A spring (50) is arranged between a bottom end of the control pin (30) and a bottom of the insertion hole (26) to provide a biasing spring force to the control pin (30) for biasing the head portion (31) out of a surface of the knuckle seat (22) for easy access and depression by a user. Under this condition, the post (32) is so located that the locking trough (322) aligns and communicates the ball hole (27) to have the ball (40) held within a selected one of the dimples (154), the ball hole (27), and the locking trough (322), as shown in FIG. 3A, and consequently, the shank (11) and the control bar (20) are fixed at a desired angular position with respect to each other. Referring to FIG. 3B, when a user or operator applies a force exceeding the biasing force of spring (50) to depress the control pin (30) down into the insertion hole (26), the location of the receiving trough (321) is now switched to such a point where the receiving trough (321) aligns and communicates the ball hole (27) and this allows the ball (40) to partially move into the receiving trough (321). Since the receiving trough (321) has a greater depth than the locking trough (322), the holding engagement between the ball (40) and the dimples (154) of the joint section (15) is released. The relative angular position between the shank (11) and the control bar (20) is then allowed to be adjusted to for example 90 degrees as shown in FIG. 3C or other angular positions as shown in FIG. 4. Once the relative angular position between the shank (11) and the control bar (20) reaches a desired location, the control pin (30) is released and thus based upward by the spring (50), and the ball (40) once again engages one dimple (154) to fix the included angle between the control bar (20) and the shank (11).

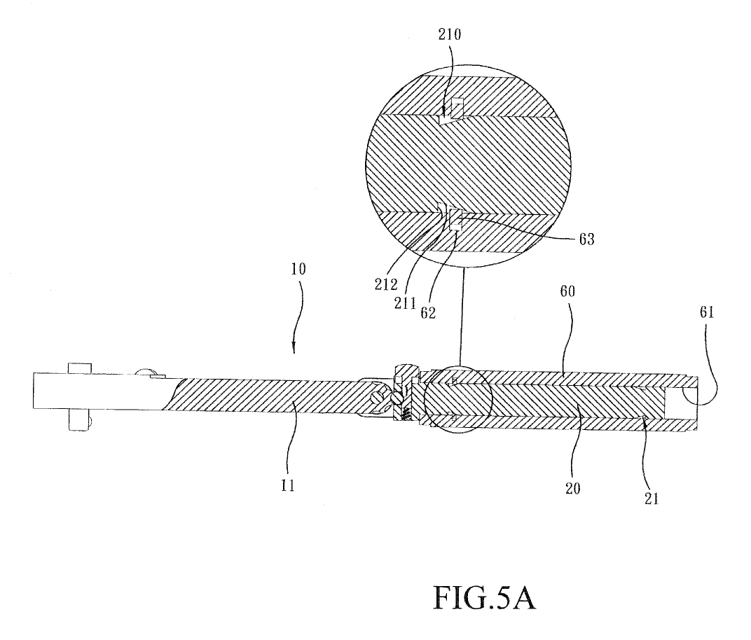

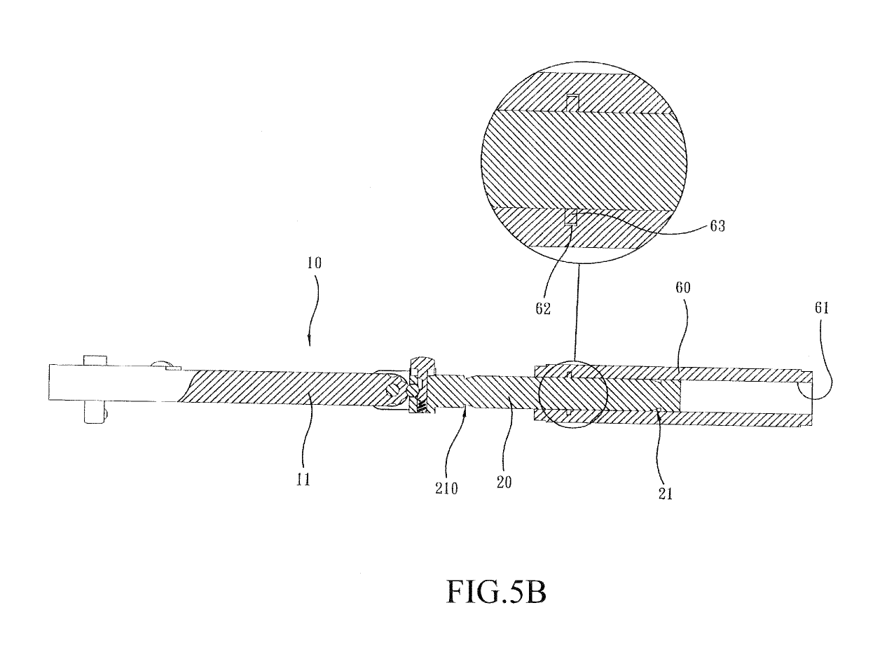

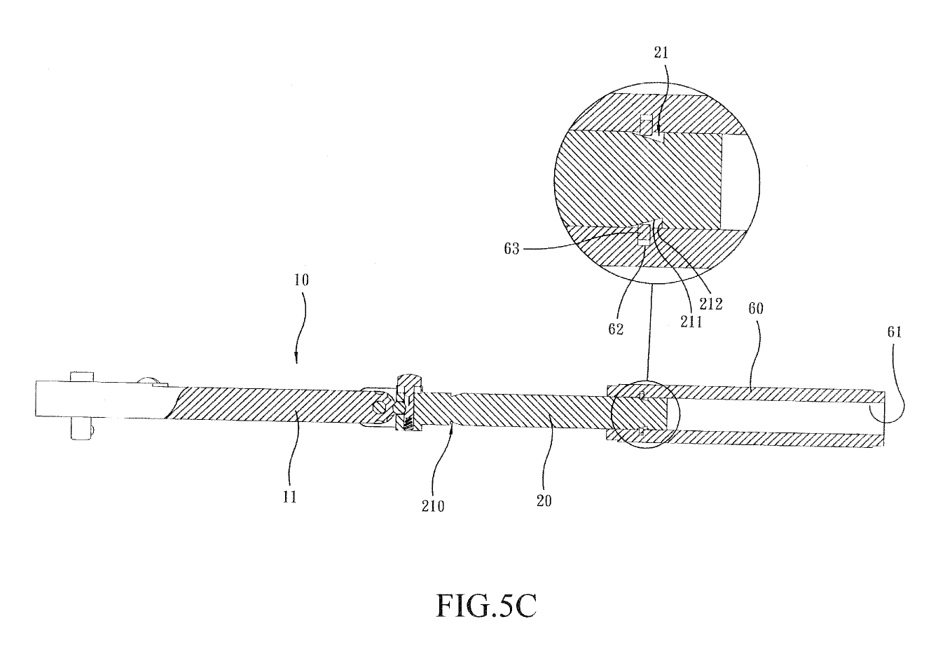

A handle (60) forms a bore (61) for rotatably and slidably, at least in a limited fashion, receiving the control bar (20) therein. The bore (61) forms in an inside surface thereof a circumferential clip groove (62) at a location close to an end of the bore. The clip groove (62) receives and retains a clip (63) therein. As shown in FIGS. 5A, 5B, and 5C, the clip (63) is configured and sized to slide along an outer circumference of the control bar (20) to be selectively positioned in any one of the positioning slots (21, 210), realizing an extendible/contractible handle arrangement constituted by the handle (60), the control bar (20), and the shank (11). The extendible/contractible arrangement allows for adjustment of torque output by the driving section (131). More importantly, as shown in FIG. 3D, under the minimum torque output condition where the control bar (20) and the shank (11) are set substantially normal to each other, the bore (61) allows the handle (60) to freely rotate about the outer circumference of the control bar (20) for a complete turn of 360 degrees, so that the handle can fast and smoothly applies a torque to the driving section (131) without causing abrasion on a user's palm holding the handle.

To this point, it can be appreciated that the present invention provides at least the following advantages:

(1) The present invention allows for adjusting an included angle between the control bar (20) and a central axis of the driving section (131), which allows the handle to be used without being constrained by a limited working space.

(2) The present invention allows for adjustment of total length of the handle (60) and the control bar (20) through the extendibility and contractibility of the handle (60), which allows for a corresponding change of the torque output, whereby saving of effort or time may be realized.

(3) The present invention allows for selectively setting an included angle between the control bar (20) and the shank (11) to 90 degrees, where an effective length of the handle is the shortest, thereby suitable for operations requiring small torques and allowing for fast and full 360-degree rotation of the driving section (131) to efficiently tighten or release a bolt through torque applied to the shank (11) by a force acting on the control bar (20). Thus, saving of time can be realized. Further, when the shank (11) rotates about the driving section (131), the present invention allows the handle (60) to freely rotate about the control bar (20), so that no abrasion on a user's palm holding the handle (60) may be induced.

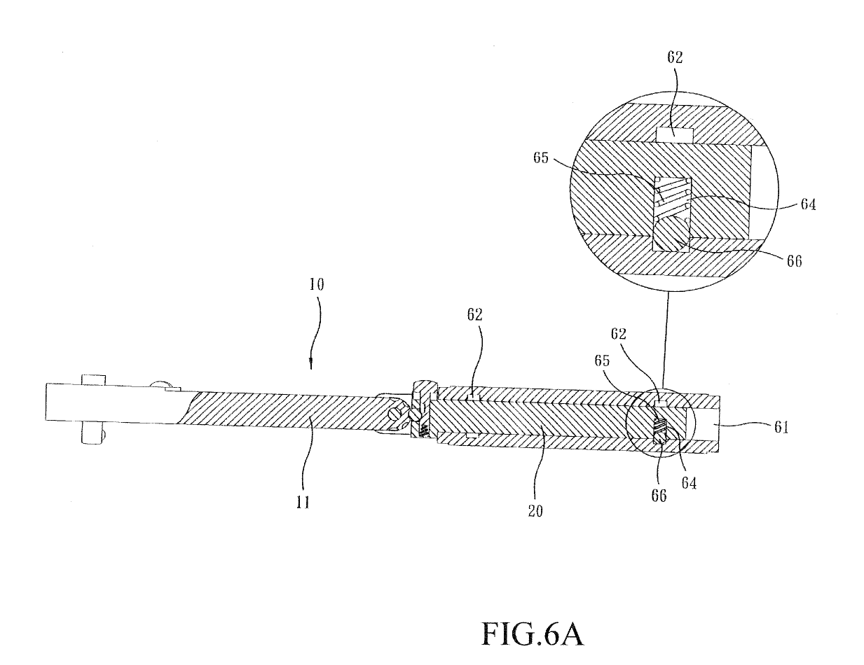

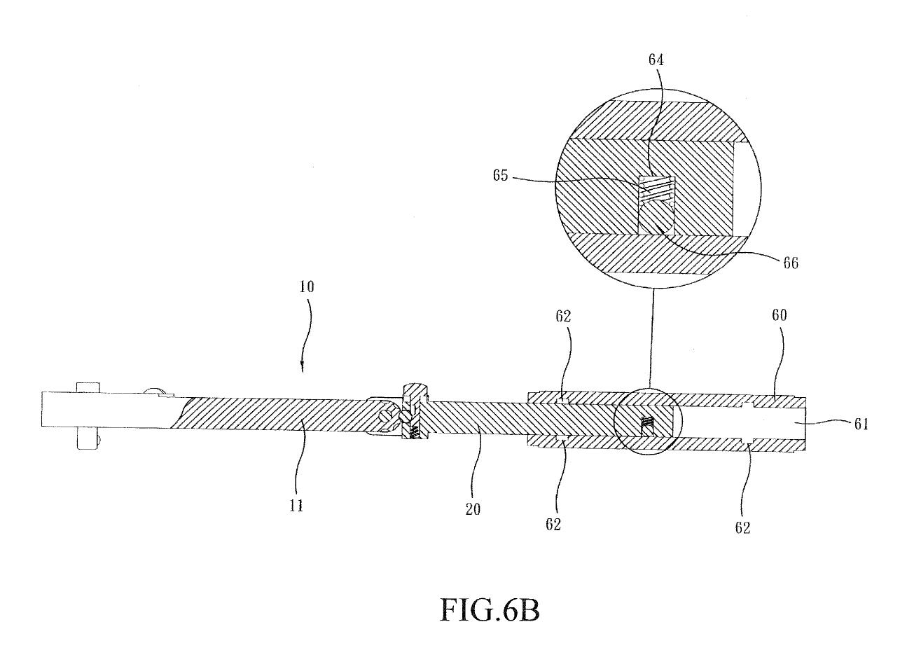

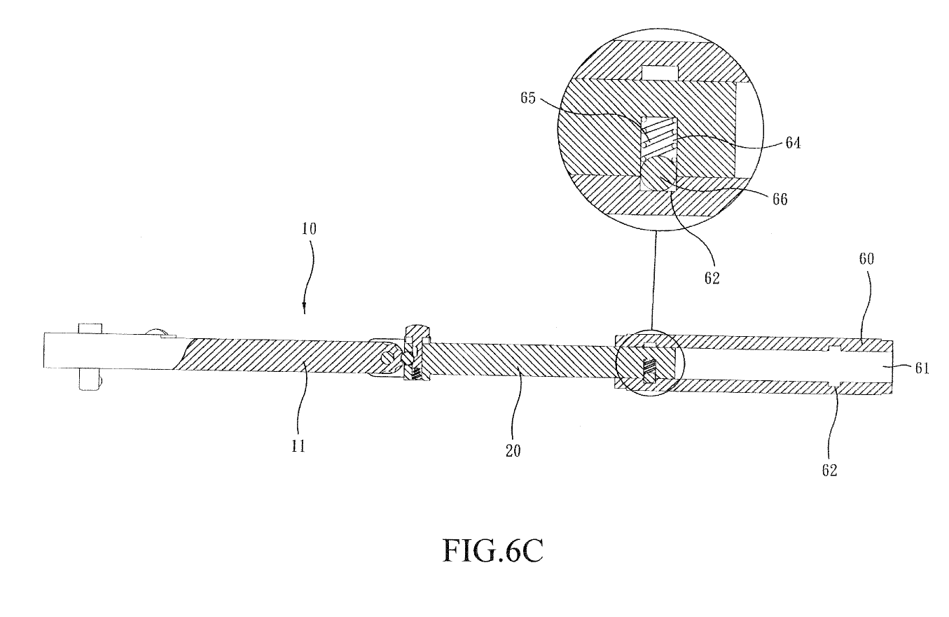

Further, referring to FIGS. 6A, 6B, and 6C, another embodiment according to the present invention is illustrated to provide a different arrangement of length adjusting and positioning between the control bar (20) and the handle (60). This embodiment is constructed so that two clip grooves (62) are defined in the inside surface of the bore (61) of the handle (60) at locations close to the two ends of the bore (60) and a spring compartment (64), which receives therein a resilient element (65), such as a spring, and a ball (66) that is biased by the resilient element (65), is defined in an outer circumferential surface of the control bar (20) at a location close to a distal end thereof, which is the end away from the knuckle seat (22). The ball (66) is normally biased by the resilient element (65) to partially project out of the spring compartment (64) and engage one of the clip grooves (62) to set the relative position between the handle (60) and the control bar (20). This provides an alternative extendible/contractible handle arrangement constituted by the handle (60), the control bar (20), and the shank (11).

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A ratchet wrench, comprising:
a wrench body, which comprises a shank, a head connected to an end of the shank, and a driving section coupled to the head;
a control bar, which has one end pivotally coupled to an opposite end of the shank with a pivot pin, the pivot pin being substantially perpendicular to but not intersecting a central axis of the driving section to allow the control bar to be angularly movable about the pivot pin for selective angular positioning with respect to the shank;
a depressible control pin, which controls angular positioning of the control bar with respect to the shank; and
a handle, which forms a bore that slidably and rotatably receives the control bar therein so that the handle, the control bar, and the shank constitute an extendible/contractible handle arrangement, the handle being freely rotatable about an outer circumference of the control bar for full turn of 360 degrees in a condition where the control bar and the shank are substantially normal to each other and shows a minimum torque output.

2. The ratchet wrench according to claim 1, wherein said opposite end of the shank forms a joint section, which forms two substantially parallel flat surfaces and a pivot hole through which the pivot pin extends, said one end of the control bar forming a knuckle seat, the knuckle seat having an end surface that forms a knuckle slot diametrically extending through the knuckle seat, the knuckle slot being delimited between two opposite side walls that respectively mate with the two flat surfaces of the joint section and form aligned joint holes at locations corresponding to the pivot hole to allow the pivot pin to extend through the joint hole and allowing the pivot pin to rotate within the pivot hole.

3. The ratchet wrench according to claim 2, wherein the joint section forms a curved surface around a center defined by the pivot hole, spaced dimples being formed in the curved surface, the knuckle seat forming an insertion hole extending in a direction substantially parallel to a slot bottom of the knuckle slot, a ball hole being formed in the slot bottom of the knuckle slot and communicating the insertion hole, he knuckle seat forming a diameter-increased recessed cavity at an outer end of the insertion hole, the control pin comprising a head portion that is receivable into/withdrawable out of the recessed cavity and a post that is slidably received in the insertion hole, the post having a circumferential surface that is recessed in a radial direction to form a receiving trough having a predetermined depth and a locking trough immediately next to the receiving trough and having a depth smaller than the predetermined depth of the receiving trough, a slope being formed between the different depths of the receiving trough and the locking trough, the ball hole movably receiving therein a ball, a spring being arranged between a bottom end of the control pin and a bottom of the insertion hole to normally bias the head portion out of a surface of the knuckle seat, whereby under such a condition, the locking trough of the post aligns and communicates the ball hole to have the ball held within a selected one of the dimples, the ball hole, and the locking trough for fixing an angular position between the shank and the control bar, and when the control pin is actuated to switch the receiving trough to align and communicate the ball hole, the holding engagement between the ball and the dimple of the joint section is released.

4. The ratchet wrench according to claim 1, wherein the control bar forms two circumferentially recessed positioning slots at two end sections thereof, the handle forming a circumferential clip groove in an inside surface of the bore at a location close to an end of the bore, the clip groove receiving and retaining therein a clip, the clip being slidable along an outer circumference of the control bar for selectively positioned in one of the positioning slots of the control bar.

5. The ratchet wrench according to claim 4, wherein each of the positioning slots is delimited by an inclined guide face and a stop wall that shows an abrupt increase of diameter at a minimum diameter of the inclined guide face.

6. The ratchet wrench according to claim 3, wherein the control bar forms two circumferentially recessed positioning slots at two end sections thereof, the handle forming a circumferential clip groove in an inside surface of the bore at a location close to an end of the bore, the clip groove receiving and retaining therein a clip, the clip being slidable along an outer circumference of the control bar for selectively positioned in one of the positioning slots of the control bar.

7. The ratchet wrench according to claim 6, wherein each of the positioning slots is delimited by an inclined guide face and a stop wall that shows an abrupt increase of diameter at a minimum diameter of the inclined guide face.

8. The ratchet wrench according to claim 1, wherein the handle forms two clip grooves in an inside surface of the bore at locations close to two ends of the bore, the control bar forming a spring compartment in an outer circumferential surface thereof; the spring compartment receiving therein a resilient element and a ball biased by the resilient element to normally and partially project out of the spring compartment to selectively engages one of the clip grooves.

9. The ratchet wrench according to claim 3, wherein the handle forms two clip grooves in an inside surface of the bore at locations close to two ends of the bore, the control bar forming a spring compartment in an outer circumferential surface thereof, the spring compartment receiving therein a resilient element and a ball biased by the resilient element to normally and partially project out of the spring compartment to selectively engages one of the clip grooves.

10. The ratchet wrench according to claim 1, wherein the head comprises a ratchet mechanism mounted therein and a direction switch that switches rotating direction of the ratchet mechanism, so that the ratchet mechanism rotates the driving section in a single predetermined direction.
